(19) United States
(12) Patent Application Publication
(10) Pub. No.: US 2015/0358643 A1
(43) Pub. Date: Dec. 10, 2015

(54) Method of Depth Coding Compatible with Arbitrary Bit-Depth

(71) Applicant: MediaTek Singapore Pte. Ltd., Singapore (SG)

(72) Inventors: Kai ZHANG, Beijing (CN); Jicheng AN, Beijing City (CN); Xianguo ZHANG, Beijing (CN); Han HUANG, Beijing (CN)

(21) Appl. No.: 14/728,088

(22) Filed: Jun. 2, 2015

Related U.S. Application Data
(63) Continuation-in-part of application No. PCT/CN2014/079155, filed on Jun. 4, 2014.

(51) Int. Cl. H04N 19/597; H04N 13/00; H04N 19/513; H04N 19/52

(52) U.S. Cl. CPC H04N 19/597; H04N 19/52; H04N 13/0048; H04N 19/521

(57) ABSTRACT

A method and apparatus for coding depth data using inter-view motion prediction (IVMP) in a three-dimensional or multi-dimensional video coding system are disclosed. In one embodiment, the bit depth of the depth data associated with the current depth map is determined first and a converted disparity vector is derived from a selected depth value depending on the bit depth. A corresponding depth block in an inter-view reference depth map in a reference view is located using the converted disparity vector. The current depth block is then encoded or decoded using the corresponding depth block as an inter-view predictor.

### CROSS REFERENCE TO RELATED APPLICATIONS

The present invention is a continuation-in-part application of and claims priority to PCT Patent Application, Serial No. PCT/CN2014/079155, filed on Jun. 4, 2014, entitled “Depth Coding Compatible with Arbitrary Bit-Depth”. The PCT Patent Application is hereby incorporated by reference in its entirety.

### FIELD OF THE INVENTION

The present invention relates to three-dimensional (3D) and multi-view video coding for depth data. In particular, the present invention relates to disparity vector derivation for inter-view motion prediction (IVMP) of depth data.

### BACKGROUND AND RELATED ART

Three-dimensional (3D) television has been a technology trend in recent years that intends to bring viewers sensational viewing experience. Various technologies have been developed to enable 3D viewing. Among them, the multi-view video is a key technology for 3DTV application among others. The traditional video is a two-dimensional (2D) medium that only provides viewers a single view of a scene from the perspective of the camera. However, the 3D video is capable of offering arbitrary viewpoints of dynamic scenes and provides viewers the sensation of realism.

The 3D video is typically created by capturing a scene using video camera with an associated device to capture depth information or using multiple cameras simultaneously, where the multiple cameras are properly located so that each camera captures the scene from one viewpoint. According to the draft three-dimensional video coding standard based on high efficiency video coding (3D-HEVC), inter-view motion prediction (IVMP) is applied to depth coding as well as the texture coding. For texture coding, neighboring block disparity vector (NBDV) method is adopted to derive the disparity vector (DV) between two views. For depth coding, however, a simplified method is disclosed by Park et al. (3D-CE2 related: Simplification of DV Derivation for Depth Coding, Joint Collaborative Team on 3D Video Coding Extension of ITU-T SG 16 WP 3 and ISO/IEC JTC 1/SC 29/WG 11, 7th Meeting: San Jose, US, 11-17 Jan. 2014, Document: JCT3V-G0074).

FIG. 1 illustrates an example of DV derivation for IVMP coding of depth data according to Park et al. Block 120 is a depth block in the dependent view (V1) and block 110 is a corresponding depth block in the base view or reference view (V0). Block 110 is located from the current block 120 via a disparity vector 112 (DV). According to Park et al., the converted DV is determined by converting a fixed depth value (i.e., 128) to the converted DV using depth value to disparity conversion 130 based on a camera model. Based on IVMP coding, the inter-view reference block (i.e., block 110) is located based on the location of the current block (i.e., block 120) using the disparity vector (i.e., DV 112). The inter-view reference block (i.e., block 110) is then used as predictor for the current block (i.e., block 120).

The use of the fixed depth value 128 apparently is based on the assumption that the depth data has 8-bit accuracy corresponding to 0 to 255 and 128 is the middle depth value of the depth range. Nevertheless, the depth data may use other bit-depths such as 10 or 12 bits. In such cases, the fixed level 128 may not be proper depth estimation for deriving the disparity vector. Therefore, it is desirable to develop IVMP coding technique for the depth data that can reliably work for various bit depths for the depth data.

### BRIEF SUMMARY OF THE INVENTION

A method and apparatus for coding depth data using inter-view motion prediction (IVMP) in a three-dimensional or multi-view video coding system are disclosed. In one embodiment, the bit depth of the depth data associated with the current depth map is determined first and a converted disparity vector is derived from a selected depth value depending on the bit depth. A corresponding depth block in an inter-view reference depth map in a reference view is located using the converted disparity vector. The current depth block is then encoded or decoded using the corresponding depth block as an inter-view predictor.

The converted disparity vector can be determined from the selected depth value using a lookup table. The selected depth value, d can be calculated according to d=1<<(BitDepth−1), BitDepth corresponds to the bit depth and “<<” corresponds to an arithmetic left shift operation. The converted disparity vector may correspond to (DepthToDisparityB [d], 0), wherein DepthToDisparityB [] is a lookup function mapping an input depth value to an output disparity vector. The bit depth of the depth data associated with the current depth map can be indicated in a sequence level of a bitstream associated with the depth data.

The IVMP coding process for the depth data can be performed only if the bit depth is 8. If the bit depth is not 8, the IVMP coding process for the depth data will not be performed. A bitstream associated with the depth data will be declared as invalid if the bitstream indicates that inter-view motion prediction is applied to the depth data and the bit depth is not 8.

### BRIEF DESCRIPTION OF THE DRAWINGS

FIG. 1 illustrates an exemplary derivation process to derive a corresponding depth block in a reference view using a converted disparity vector for a current depth block in a dependent view according to an existing depth coding method using inter-view motion prediction.

FIG. 2 illustrates an exemplary derivation process to derive a corresponding depth block in a reference view using a converted disparity vector for a current depth block in a dependent view according to an embodiment of the present invention.

FIG. 3 illustrates a flowchart of an exemplary system incorporating an embodiment of the present invention to derive a converted disparity vector based on the bit depth of the depth data for inter-view motion prediction.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned before, when the depth data uses a bit depth other than 8 bits, the fixed depth value, 128 being used for depth-to-disparity conversion may not be a good estimation of depth value. Therefore, it is desirable to develop a depth value estimation that can fit to arbitrary bit depth.

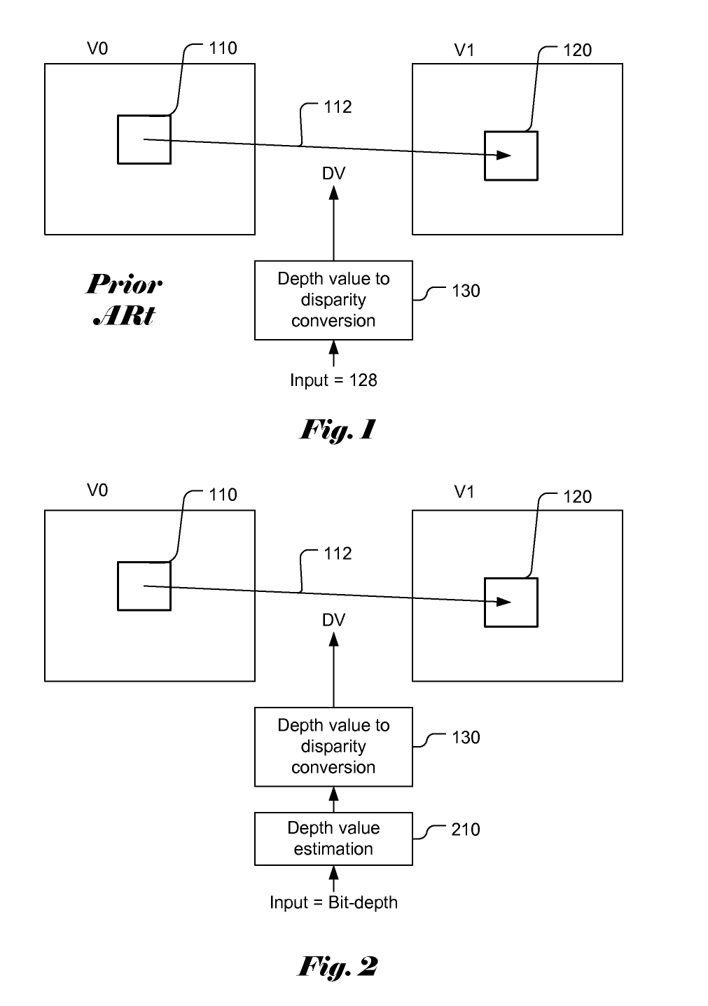

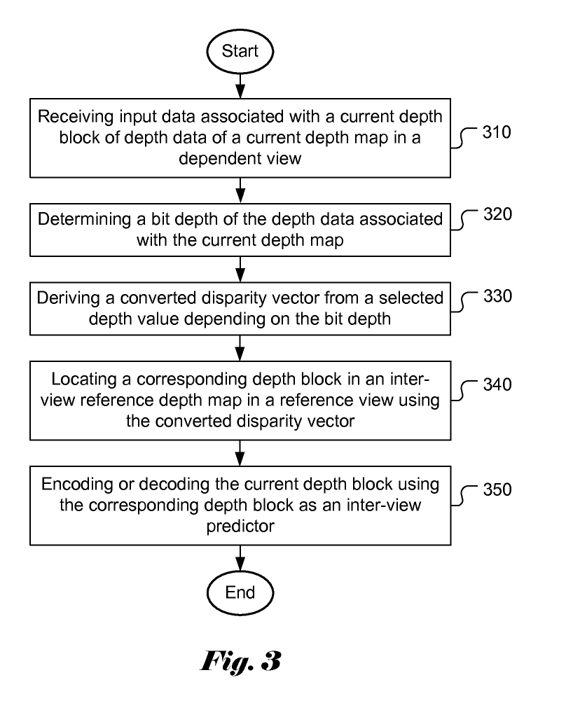

In one embodiment, the disparity vector between two views used by inter-view motion prediction (IVMP) coding of depth data is derived depending on the bit-depth of depth data as indicated in the current sequence. FIG. 2 illustrates an example of IVMP coding of depth data using disparity vector derived according to an embodiment of the present invention. Instead of using the fixed depth value 128 shown in FIG. 1, the current invention uses the bit depth as input to the depth value estimation 210 to derive an estimated depth value as shown in FIG. 2. The estimated depth value is used by depth value to disparity conversion 130 to derive the converted disparity vector DV. The converted DV is also termed as a derived DV in this disclosure. As shown in FIG. 2, after the estimated depth value is determined by disparity conversion 130, the rest IVMP coding process is the same as the conventional IVMP coding. In other words, the estimated depth value is used to derive the converted DV for IVMP coding using depth value to disparity conversion 130.

In another embodiment, the estimated depth value can be based on the bit depth of the current depth component. The estimated depth value is used by depth value to disparity conversion 130 to derive the converted disparity vector DV. Furthermore, the derived DV is used by the IVMP coding to locate the inter-view reference block for the current depth block.

Following procedure illustrates an example to derive a disparity vector (MvDisp) between two views for IVMP coding based on the bit depth. The disparity vector MvDisp between two views required by IVMP is calculated as:

MvDisp=(DepthToDisparityB [(1<<(BitDepth−1))], 0), (1)

where DepthToDisparityB is a function converting a depth value to a horizontal component of the corresponding disparity vector, and BitDepth is the bit-depth for the current depth component. In equation (1), the vertical disparity is assumed to be 0 since multi-view cameras are often configured horizontally. Nevertheless, a corresponding depth-to-disparity function can be used for other multi-view camera configuration. The conversion may also be efficiently implemented as a lookup table. In the above example, the estimated depth value corresponds to (1<<(BitDepth−1), where “<<” corresponds to the arithmetic shift less operation. Therefore, if BitDepth is 10, the estimated depth value is 512 and if BitDepth is 12, the estimated depth value is 2048.

In another embodiment, the inter-view motion prediction coding for the depth data is allowed only if the bit-depth for a depth component is 8. If the bit-depth is not 8 for the depth component is not 8, the inter-view motion prediction coding for the depth data is not allowed. A bitstream associated with the depth data is declared invalid if the bitstream indicates that inter-view motion prediction is applied to the depth data and the bit depth is not 8.

FIG. 3 illustrates a flowchart of an exemplary system incorporating an embodiment of the present invention to derive a converted disparity vector based on the bit depth of the depth data for inter-view motion prediction. The system is, for example, a three-dimensional video coding system or a multi-dimensional video coding system. The system receives input data associated with a current depth block of depth data of a current depth map in a dependent view as shown in step 310. For encoding, the input data corresponds to depth data to be encoded. For decoding, the input data corresponds to coded depth data to be decoded. The input data may be retrieved from memory (e.g., computer memory, buffer (RAM or DRAM) or other media) or from a processor. A bit depth of the depth data associated with the current depth map is determined in step 320. A converted disparity vector is derived from a selected depth value depending on the bit depth as shown in step 330. A corresponding depth block in an inter-view reference depth map in a reference view is located using the converted disparity vector as shown in step 340. The current depth block is encoded or decoded using the corresponding depth block as an inter-view predictor as shown in step 350.

The flowchart shown above is intended to illustrate an example of inter-view motion prediction for depth data according to the present invention. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding depth data using inter-view motion prediction (IVMP) for a three-dimensional or multi-view video coding system, the method comprising:
receiving input data associated with a current depth block of depth data of a current depth map in a dependent view;
determining a bit depth of the depth data associated with the current depth map;
deriving a converted disparity vector from a selected depth value depending on the bit depth;
locating a corresponding depth block in an inter-view reference depth map in a reference view using the converted disparity vector; and
encoding or decoding the current depth block using the corresponding depth block as an inter-view predictor.

2. The method of claim 1, wherein the converted disparity vector is determined from the selected depth value using a lookup table.

3. The method of claim 1, wherein the selected depth value, d is calculated according to d=1<<(BitDepth−1), BitDepth corresponds to the bit depth and “<<” corresponds to an arithmetic left shift operation.

4. The method of claim 3, wherein the converted disparity vector corresponds to (DepthToDisparityB [d], 0), wherein DepthToDisparityB [] is a lookup function mapping an input depth value to an output disparity vector.

5. The method of claim 1, wherein the bit depth of the depth data associated with the current depth map is indicated in a sequence level of a bitstream associated with the depth data.

6. The method of claim 1, wherein said determining the converted disparity vector, said locating the corresponding depth block and said encoding or decoding the current depth block using the corresponding depth block as the inter-view predictor are performed only if the bit depth is 8.

7. The method of claim 1, wherein said encoding or decoding the current depth block using the corresponding depth block as the inter-view predictor is not performed if the bit depth is not 8.

8. The method of claim 1, wherein a bitstream associated with the depth data is invalid if the bitstream indicates that inter-view motion prediction is applied to the depth data and the bit depth is not 8.

9. An apparatus for coding depth data using inter-view motion prediction (IVMP) for a three-dimensional or multi-view video coding system, the apparatus comprising one or more electronic circuits configured to:
receive input data associated with a current depth block of depth data of a current depth map in a dependent view;
determine a bit depth of the depth data associated with the current depth map;
determine a converted disparity vector from a selected depth value depending on the bit depth;
locate a corresponding depth block in a reference depth map in a reference view using the converted disparity vector; and
encode or decode the current depth block using the corresponding depth block as an inter-view predictor.

10. The apparatus of claim 9, wherein the converted disparity vector is determined from the selected depth value using a lookup table.

11. The apparatus of claim 9, wherein the selected depth value, d is calculated according to d=1<<(BitDepth−1), BitDepth corresponds to the bit depth and “<<” corresponds to an arithmetic left shift operation.

12. The apparatus of claim 11, wherein the converted disparity vector corresponds to (DepthToDisparityB [d], 0), wherein DepthToDisparityB [] is a lookup function mapping an input depth value to an output disparity vector.

13. The apparatus of claim 9, wherein the bit depth of the depth data associated with the current depth map is indicated in a sequence level of a bitstream associated with the depth data.

14. The apparatus of claim 9, wherein said determining the converted disparity vector, said locating the corresponding depth block and said encoding or decoding the current depth block using the corresponding depth block as the inter-view predictor are performed only if the bit depth is 8.

15. The apparatus of claim 9, wherein said encoding or decoding the current depth block using the corresponding depth block as the inter-view predictor is not performed if the bit depth is not 8.

16. The apparatus of claim 9, wherein a bitstream associated with the depth data is invalid if the bitstream indicates that inter-view motion prediction is applied to the depth data and the bit depth is not 8.
